(19) United States
(12) Patent Application Publication
(10) Pub. No.: US 2004/0203683 A1
(43) Pub. Date: Oct. 14, 2004

(54) Revenue sharing for interchangeable covers of wireless mobile phones having contents

(76) Inventors: G. Eric Engstrom, Kirkland, WA (US); Tyrol R. Graham, Seattle, WA (US); Peter Zatloukal, Duvall, WA (US); Christopher H. Phillips, Woodinville, WA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/251,701

(22) Filed: Sep. 19, 2002

(51) Int. Cl. H04B 1/38; H04M 3/42; H04M 3/00

(52) U.S. Cl. 455/418; 455/90.1; 455/414.1; 455/575.1

(57) ABSTRACT

An interchangeable covers having content for customizing wireless mobile phones is further provided with an indicator to denote whether the cover has been put to use. A wireless mobile phone is equipped to transmit a message to convey a detected first use of the cover. A server is equipped to store the message in detail or in aggregate. The server may also in addition or in lieu of said storing, accrue compensation for at least a selected one of a contributor of the content, a manufacturer of the wireless mobile phone, and a wireless mobile phone service provider.

### FIELD OF THE INVENTION

The present invention relates to the field of wireless mobile telephony. More specifically, the present invention is related to revenue sharing for interchangeable covers having content designed for customizing wireless mobile phones.

### BACKGROUND OF THE INVENTION

Advances in microprocessor and telecommunication technology have led to wide spread deployment and adoption of wireless mobile phones. In addition to telephony, the latest wireless mobile phones are often equipped with advanced capabilities such as access to the World Wide Web (WWW), emails, instant messaging, and so forth.

However, in recent years, because adoption of new contents often require cooperative promotion between the content contributors/distributors and the carriers, i.e. the wireless mobile phone service providers, the introduction of additional rich contents has run into some hurdles. Part of the problem is associated with the manner in which the costs of the new contents are underwritten, or the manner in which the revenues for the new contents are collected and shared among the parties.

Under the prior art, typically, the costs or revenues for the new content are either collected from the consumers/subscribers directly, without participation, i.e. sharing, by the carriers, or indirectly through a revenue sharing model having the content contributors and distributors share a portion of the carriers' revenues.

The former direct approach is often limited by price sensitivity, i.e. the amount the one time or installment price the content contributors/distributors can charge the consumers/subscribers.

The latter indirect approach premises on the assumption that the new contents induce increase usage of call times by the subscribers, which in turn results in increase in revenue to the carriers. Since the increase in usage of call time is resulted from the new contents, accordingly, the contributors/distributors of the new contents are entitled to share a portion of the carriers' revenues.

However, in practice, it is difficult to forecast as well as to evaluate the actual impact or contribution of a new content to the growth in revenue of a carrier, especially when there are multiple new contents. Resultantly, the model is difficult to administer, which in turn impacts new content introduction.

Thus, an improved approach to revenue collection and sharing that induces more contents for wireless mobile telephony is desired.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an example wireless mobile telephony context within which the present invention may be practiced;

FIG. 2 illustrates an overview of the present invention in accordance with one embodiment, in a block diagram form;

FIG. 3 illustrates the method of doing business of the present invention, in accordance with one embodiment;

FIGS. 4a-4b illustrate a perspective view and a side view, respectively, of the interchangeable cover with content and first use indicator of the present invention, in accordance with one embodiment;

FIG. 4c illustrates a front view of a wireless mobile phone of the present invention, having the interchangeable cover of FIG. 4a-4a attached, in accordance with one embodiment;

FIG. 5 illustrates an architectural view of the wireless mobile phone of the present invention, in accordance with one embodiment;

FIG. 6 illustrates the operational flow of the relevant aspects of the first use reporting logic of FIG. 2, in accordance with one embodiment;

FIG. 7 illustrates an architectural view of the first use reports receiving server of FIG. 1, in accordance with one embodiment; and

FIG. 8 illustrates the operational flow of the relevant aspects of the first use reports receiving logic of FIG. 2, in accordance with one embodiment.

### DETAILED DESCRIPTION OF EMBODIMENTS OF THE INVENTION

The present invention includes a method for doing business, and apparatuses in support of the method for doing business.

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will be apparent to one skilled in the art that the present invention may be practiced without the specific details. In other instances, well-known features are omitted or simplified in order not to obscure the present invention.

### Terminology

Parts of the description will be presented in wireless mobile telephony terms, such as data, flag, transmit, receive, and so forth, consistent with the manner commonly employed by those skilled in the art to convey the substance of their work to others skilled in the art. As well understood by those skilled in the art, these quantities take the form of electrical, magnetic, or optical signals capable of being stored, transferred, combined, and otherwise manipulated through electrical and/or optical components of a processor and its subsystems.

Part of the descriptions will employ various abbreviations, including but are not limited to:

| | |
|---|---|
| ASIC | Application Specific Integrated Circuit |
| LAN | Local Area Network |
| PSTN | Public Switched Telephone Network |
| SMS | Small Messaging Service |

The term “wireless mobile phone” as used herein (in the claims as well as in the specification) refers to a “handset” having wireless mobile telephony capability that allows a user of the “handset” to communicate with a callee, as long as the user is within transmission reach of a base station of a wireless telephone service network. The user may be stationary or mobile. The term as used includes the conventional “handsets” as well as “handsets” that are digital computing devices equipped with wireless mobile telephony capability, such as a personal digital assistant (PDA) or palm-sized computer so equipped.

The term “content” as used herein (in the claims as well as in the specification) includes non-executable contents, such as audio and/or video contents, as well as executable contents, such as applications.

### Section Headings, Order of Descriptions and Embodiments

Section headings are merely employed to improve readability, and they are not to be construed to restrict or narrow the present invention.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

### Overview

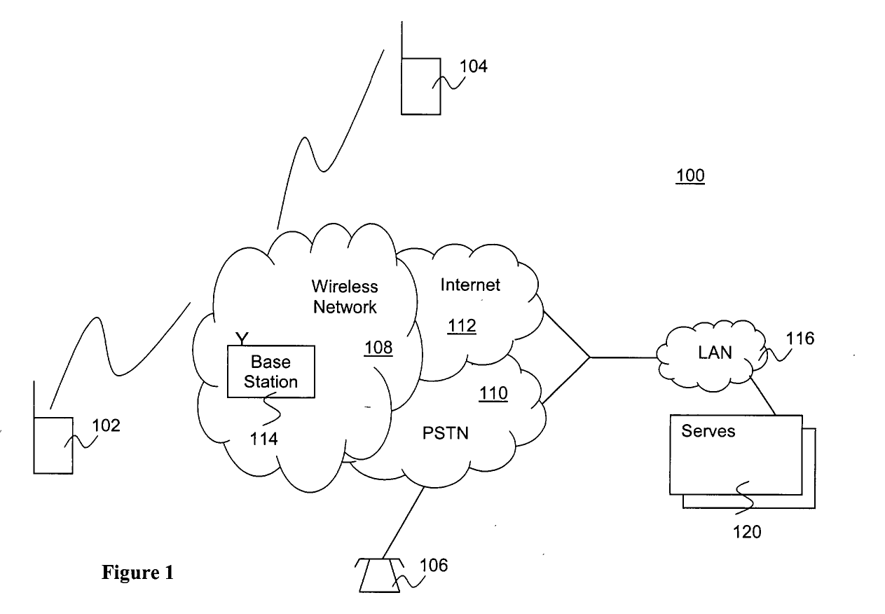

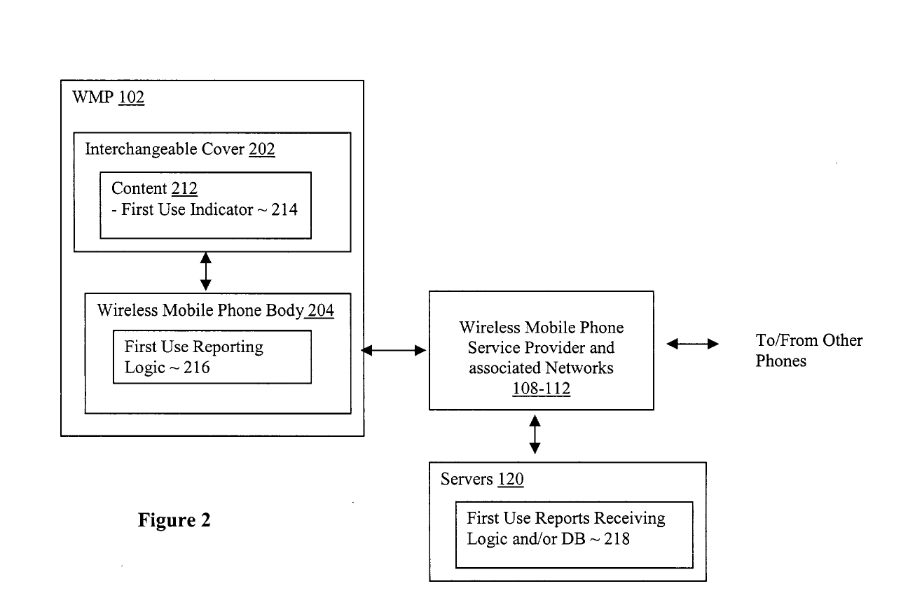

FIGS. 1-2 illustrate an overview of the present invention, in accordance with one embodiment. More specifically, FIG. 1 illustrates one embodiment of an environment 100 within which the present invention may be practiced, and FIG. 2 illustrates the interrelationships between selected elements of the present invention.

As illustrated in FIG. 1, a user of a wireless mobile phone (WMP) 102 of in environment 100 may place calls to another WMP user, such as user of WMP 104, or another line based handset user, such as user of handset 106, via wireless networks 108, PSTN 110, and/or Internet 112, through which WMP 102 and 104 and handset 106 are communicatively coupled.

Wireless networks 108 refer to the wireless service networks of wireless telephone service providers, such as the wireless service networks offered by companies like AT&T Wireless of Redmond, Wash., Sprint of Overland Park, Kans., and so forth. Wireless networks 108 include base stations, such as base station 114, switches/routers (not shown), and so forth. PSTN 110 refers to the traditional circuit switched network of line based telephone services, such as the line circuits operated by Qwest of Denver, Colo., Bell South of Atlanta, Ga., and so forth. Internet 112 refers to the famous packet based networking backbone inter-networking private and public networks, such as intranet 116 of wireless service provider 130.

WMP 102, as will be described in more detail below, is advantageously equipped with an interchangeable cover of the present invention having contents and first use indicator, and a phone core of the present invention having interchangeable cover first use reporting logic.

Customizing or further enriching the functionalities of a wireless mobile phone is the subject matter of co-pending U.S. patent application Ser. No. 10/087,098, filed on Mar. 1, 2002, and entitled “PERSONALIZING ELECTRONIC DEVICES AND SMART COVERING”, which specification is hereby incorporated by reference (for U.S. version of the present application).

To facilitate practice of the present invention, environment 100 also includes server or servers 120 and LAN 116 coupling servers 120 to PSTN 110 and/or Internet 112. As will be described in more detail below, servers 120 is advantageously provided with the first use reports receiving function of the present invention. WMP 102 and servers 120 are communicatively coupled to each other through one or more of networks 108-112.

FIG. 2 illustrates the relationships between interchangeable cover 202 and phone core 204 of WMP 102, service provider and associated networks 108-112, and servers 120 in further detail, in accordance with one embodiment. As illustrated and alluded earlier, interchangeable cover 202 is endowed with contents 212 to further enrich the functionalities of WMP 102. In particular, interchange cover 202 is also endowed with an indicator 214 denoting whether the interchangeable cover 202 has been put to use.

In one embodiment, indicator 214 is in the form of a flag. In one embodiment, the flag is encrypted using a private key of a public-private key pair of a developer of interchangeable cover 202.

In one embodiment, both contents 212 and first use indicator 214 are stored in an embedded storage medium that is a part of interchangeable cover 202. Examples of suitable embedded storage medium include but are not limited EEPROM, Flash memory, and other non-volatile memory of like kind. In alternate embodiments, the present invention may also be practiced with volatile storage medium properly supported by an appropriate power source.

Still referring to FIG. 2, as illustrated and alluded to earlier, phone core 204 of WMP 102, in addition to conventional wireless mobile telephony elements, is endowed with first use reporting logic 216 for reporting a first use condition, whenever an interchangeable cover 202 with contents is put to use for the first time.

In one embodiment, the reporting is made in the form of a SMS message, transmitted to server 120 via wireless service provider and associated networks 108-112. In alternate embodiments, the reporting may be made employing other messaging protocols, or in other manners.

Server 120 is complementarily equipped with first use reports receiving logic and/or database 218 for receiving the first use reports. In various embodiments, first use reports receiving logic and/or database 218 simply logs the first use reports. In other embodiments, first use reports receiving logic and/or database 218 in addition to, or in lieu of said logging, aggregates the first use reports. The aggregation may be performed by cover families or types, or by any grouping criteria.

In yet other embodiments, first use reports receiving logic and/or database 218 in addition to, or in lieu of foregoing logging/aggregation, accrues compensation for at least one of the content contributor of the included content of cover 202 which first use is being reported, the manufacturer of phone core 204, and the wireless mobile phone service provider.

In some embodiments, first use reports receiving logic and/or database 218 in addition to, or in lieu of foregoing logging/aggregation, accrues compensation for at least two of the content contributor of the included content of cover 202 which first use is being reported, the manufacturer of phone core 204, and the wireless mobile phone service provider.

In other embodiments, first use reports receiving logic and/or database 218 in addition to, or in lieu of foregoing logging/aggregation, accrues compensation for each of the content contributor of the included content of cover 202 which first use is being reported, the manufacturer of phone core 204, and the wireless mobile phone service provider.

In other embodiments, the present invention may also be practiced with compensation being accrued, based on the reported first uses, for more or less parties. In each of the above described/mentioned embodiments, the exact percentage or amount of compensation each participating party receives is application dependent, and may vary from one cover family/type to another. That is, the exact percentage/amount of compensation among the parties is non-essential to the practice of the present invention.

Thus, it can be seen, the present invention advantageously provides a new alternative approach to the underwriting of the costs and/or collecting/sharing revenues of new contents among the parties who collectively contribute to the adoption of new contents for wireless mobile phone.

Except for the teachings of the present invention incorporated, the various elements shown in FIG. 1-2, i.e. the conventional elements of WMP 102-104 and servers 120, handset 106, networks 108-112, base station 114, and LAN 116, are all otherwise known in the art. Any one of a wide range of implementations of these elements may be employed to practice the present invention. Accordingly, except for the teachings of the present invention incorporated, the elements 102-120 are otherwise not further described.

### Business Method

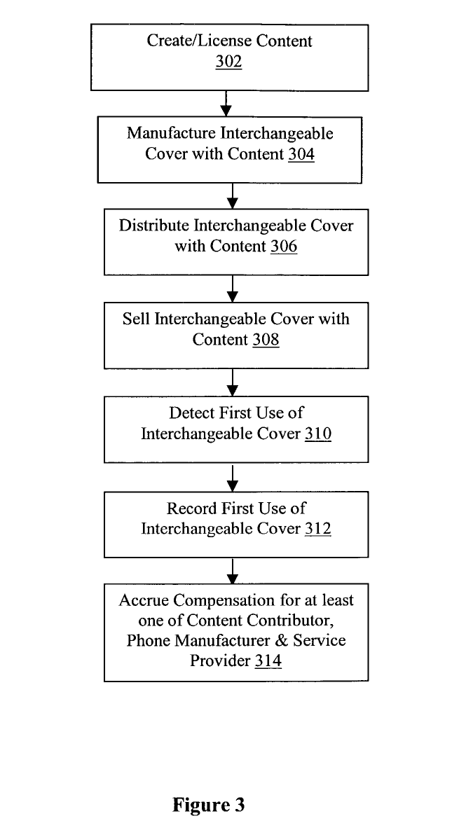

FIG. 3 illustrates the business method of the present invention, in accordance with one embodiment. As illustrated, the method starts with the creation or the licensing of the contents to be included in a line of interchangeable covers, block 302. Upon creating/licensing the embedded content, the interchangeable covers 202 of the present invention are manufactured, block 304. Upon manufacturing, the interchangeable covers 202 of the present invention are distributed and sold, blocks 306-308. Distribution and sales of the interchangeable cover 202 may be done any one of a number of known distribution and sales channels, including but are not limited to in-store retailers, or online retailers

When the first use of one of the interchangeable cover 202 of the present invention is detected, the detected first use is reported, block 310. The received reports are logged and/or aggregated, block 312.

Then, based on the reported first uses, compensations are accrued for at least one of the content contributor of the included content of cover 202 which first use is being reported, the manufacturer of phone core 204, and the wireless mobile phone service provider.

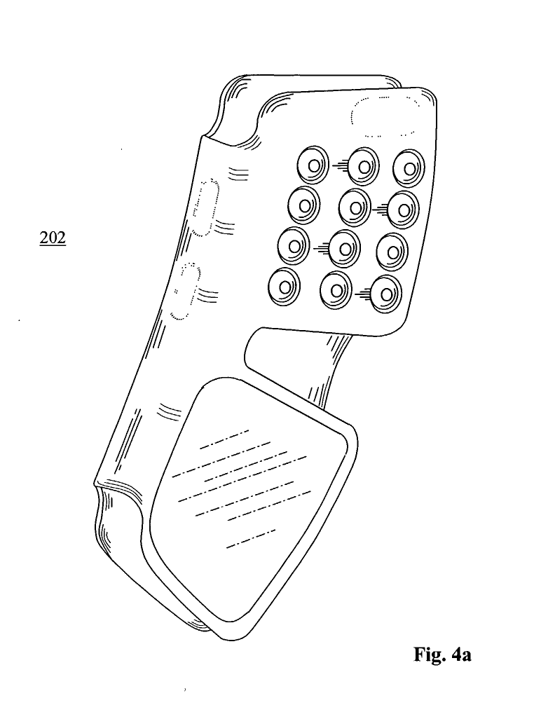

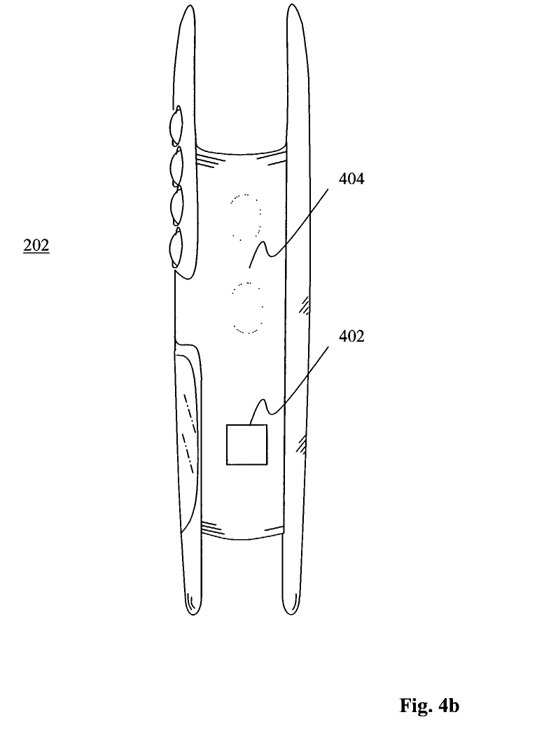

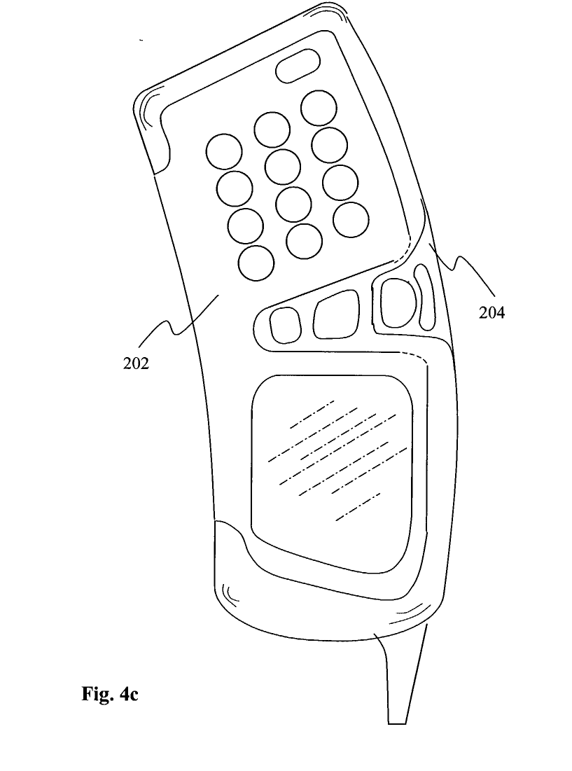

FIGS. 4a-4c illustrate interchangeable cover 202 in further detail, in accordance with one embodiment. FIG. 4a is a perspective view of the embodiment, which has a substantially U-shaped cover body, and designed to be snapped onto phone core 204 via a substantially side way motion (as defined by the expected orientation of phone core 204).

FIG. 4c illustrates a front view of the assembly, that is having interchangeable cover 202 and phone core 204 illustrated with cover 202 having been snapped on, i.e. attached, to phone core 204.

FIG. 4b is a side view, looking into the substantially U-shaped body of cover 202. For the embodiment, storage medium 402 having contents 212 and first use indicator 214 is disposed on the inside surface of side wall 404 of cover 202.

Of course, in alternate embodiments, storage medium 402 may be disposed in other surfaces of cover 202. Further, cover 202 may have other shapes as well as other attachment approaches.

### Wireless Mobile Phone

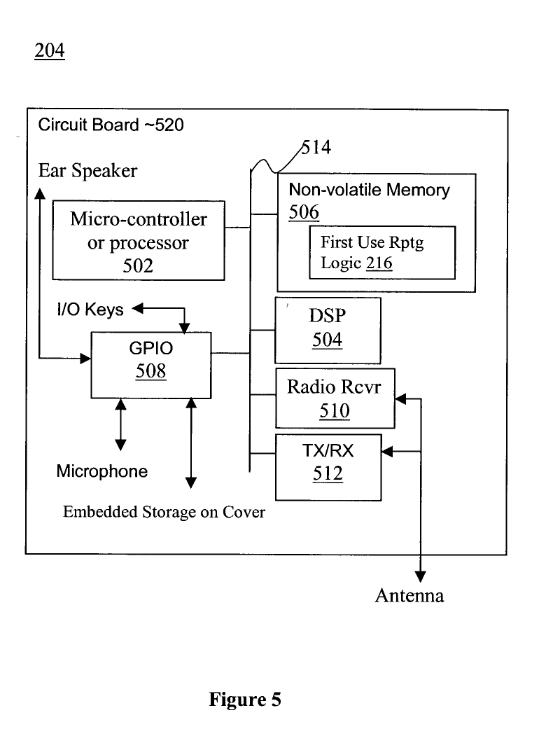

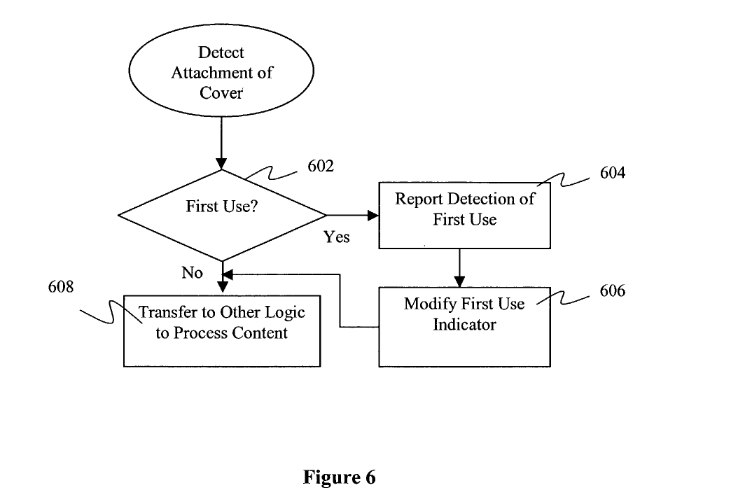

FIGS. 5-6 illustrate phone core 204 in further detail, in accordance with one embodiment. More specifically, FIG. 5 illustrates an architectural view of phone core 204, whereas FIG. 6 illustrates the operational flow of the relevant aspects of first use reporting logic 216, in accordance with one embodiment.

As illustrated in FIG. 5, phone core 204 includes elements found in conventional wireless mobile client devices, such as micro-controller/processor 502, digital signal processor (DSP) 504, non-volatile memory 506, general purpose input/output (GPIO) interface 508, radio receiver 510, and transmit/receive (TX/RX) 512 (also known as a transceiver), coupled to each other via bus 514, and disposed on a circuit board 520.

As described earlier, phone core 204 is endowed with a software implementation of first use reporting logic 216. In alternate embodiments, first use reporting logic 216 may be implemented in hardware using e.g. ASIC.

Except for first use reporting logic 216 provided to phone core 204, which relevant operating logic will be described more fully below, each of these elements 502-514 performs its conventional function known in the art, and is intended to represent a broad range of such element and its equivalents. In particular, GPIO 508 is configured to generate an interrupt notifying control processor 502 of the detection of an attachment of an interchangeable cover 202, which in turn directly or indirectly causes first use reporting logic 216 to be invoked and executed.

Further, TX/RX 512 may be designed to support one or more of any of the known signaling protocols, including but are not limited to CDMA, TDMA, GSM, and so forth. Moreover TX/RX 512 may be implemented using separate transmitter and receiver.

Accordingly, elements 502-514 will not be further described.

As illustrated in FIG. 6, upon invocation, first use reporting logic 216 determines whether the detected cover 202 is being put to use for the first time, block 602. In one embodiment, the determination includes accessing embedded storage 402 for the first use indicator 214. In one embodiment, if the detected cover 202 is being put to use for the first time, the first use indicator 214 will be present. If the detected cover 202 has been put to use before, the first use indicator 214 will not be present, by virtue of the fact that it would have been deleted by first use reporting logic 216.

In one embodiment, the first use indicator 214 is encrypted with a private key of the developer of the detected cover 202, and recovery of the first use indicator 214 further includes decrypting it using a public key of the developer of the detected cover 202.

Continuing to refer to FIG. 6, upon determining that the detected cover 202 is being put to use for the first time, first use reporting logic 216 transmits a message to convey the detection of the first use of the detected cover 202. As described earlier, in one embodiment, the message is transmitted as a SMS message to server 120. Further, the message includes one or more identifiers identifying the detected cover uniquely (e.g. its serial number) or as a member of a line of interchangeable covers (e.g. cover model number).

In alternate embodiments, the message may include other information, as well as being transmitted in other formats and/or protocols.

In one embodiment, server 120 is a server administered by the developer of interchangeable cover 202. In alternate embodiments, server 120 may be administered by the carrier or third parties.

Additionally, upon successfully reporting the detected first use (e.g. receiving an acknowledgement of the reporting), as alluded to earlier, for the embodiment, first use reporting logic 216 deletes or otherwise modifies first use indicator 214, block 606, such that, when detected by other first use reporting logic of other phone cores 204, the particular cover 202 will not be considered being put to use for the first time.

Thereafter, or upon initially determining that the detected cover 202 is not being put to use the first time, for the embodiment, first use reporting logic 216 transfers execution control to other logic to process contents 212 to customize or otherwise enhance the functionalities of phone core 204.

### First User Reports Receiving Servers

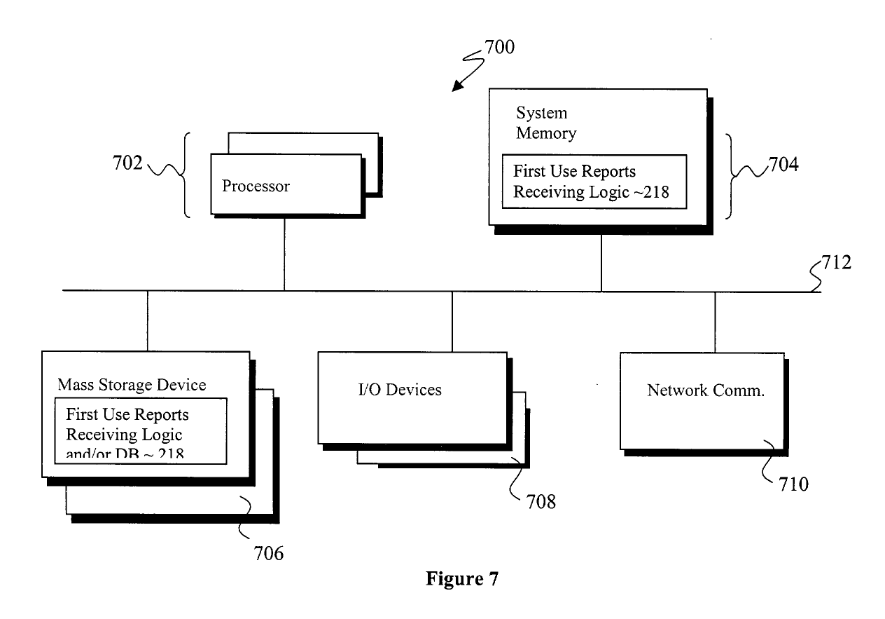

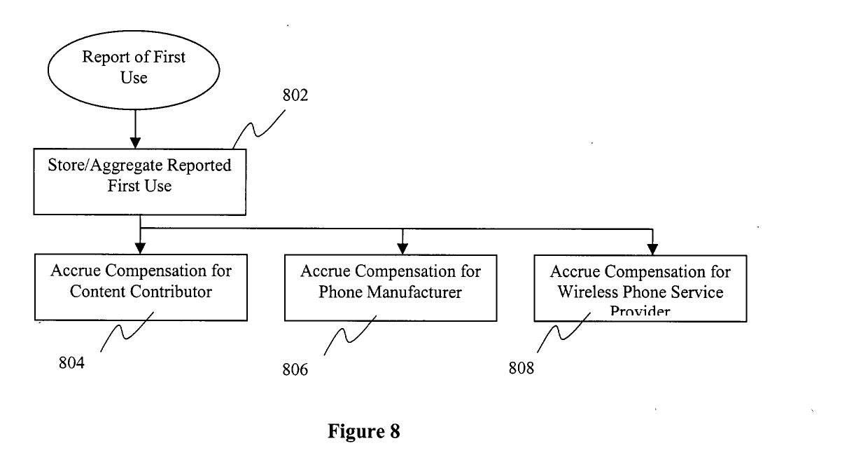

FIGS. 7-8 illustrate server 120 in further detail, in accordance with one embodiment. More specifically, FIG. 7 illustrates an architectural view of server 120, whereas FIG. 8 illustrates the operational flow of the relevant aspects of first use reports receiving logic 218.

As illustrated, server 700 includes one or more processors 702, and system memory 704. Additionally, server 700 includes mass storage devices 706 (such as diskette, hard drive, CDROM and so forth), input/output devices 708 (such as keyboard, cursor control and so forth) and communication interfaces 710 (such as network interface cards, modems and so forth). The elements are coupled to each other via system bus 712, which represents one or more buses. In the case of multiple buses, they are bridged by one or more bus bridges (not shown).

Each of these elements performs its conventional functions known in the art. In particular, system memory 704 and mass storage 706 are employed to store a working copy and a permanent copy of the programming instructions implementing first use reports receiving logic 218. Additionally, mass storage 706 is employed to store the logged/aggregated reported first uses, as well as accrued compensations, if applicable.

The permanent copy of the programming instructions may be loaded into mass storage 706 in the factory, or in the field, through e.g. a distribution medium (not shown) or through communication interface 710 (from a distribution server (not shown)).

The constitution of these elements 702-712 are known, and accordingly will not be further described.

As illustrated in FIG. 8, upon receipt of a message from a WMP 102 conveying detection of a first use of an interchangeable cover 202, first use reports receiving logic 218 logs and/or aggregates the reported first use, block 802. Additionally, for the embodiment, first use reports receiving logic 218 further accrues compensations for the contributor of the content of the detected first use cover 202, the manufacturer of the reporting phone core 204, and the carrier, i.e. the wireless mobile phone service provider of reporting phone core 204.

As described earlier, in alternate embodiments, accrual of compensations may be performed for additional entities, or separately by other entities based on the logged/aggregated data.

### Conclusion and Epilogue

Thus, it can be seen from the above descriptions, a novel method for sharing revenue among the developers of interchangeable covers with contents for wireless mobile phones, the content contributors, the phone manufacturers and the carriers, including interchangeable covers with first use indicators, wireless mobile phones with first use reporting logic and servers with first use reports receiving logic, have been described.

While the present invention has been described in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A method for doing business comprising:
selling an interchangeable cover having content to customize a wireless mobile phone; and
upon receiving reporting of detection of the interchangeable cover being put to use on a wireless mobile phone for the first time, accruing compensation for at least a selected one of a contributor of said content, a manufacturer of said wireless mobile phone on which the interchangeable cover is first put to use, and a wireless mobile phone service provider providing wireless mobile phone service to said wireless mobile phone.

2. The method of claim 1, wherein said accruing of compensation comprises accruing compensation for at least two of said content contributor, said wireless mobile phone manufacturer, and said wireless mobile phone service provider.

3. The method of claim 1, wherein said accruing of compensation comprises accruing compensation for each of said content contributor, said wireless mobile phone manufacturer, and said wireless mobile phone service provider.

4. The method of claim 1, wherein said selling comprises selling said interchangeable cover through a selected one of an on-line retailer and an in-store retailer.

5. The method of claim 1, wherein the method further comprises distributing said interchangeable cover.

6. The method of claim 1, wherein the method further comprises manufacturing said interchangeable cover.

7. The method of claim 1, wherein the method further comprises designing said interchangeable cover.

8. The method of claim 1, wherein the method further comprises developing said content for said interchangeable cover.

9. In a wireless mobile phone, a method of operation:
detecting attachment of an interchangeable cover having content for use to customize the wireless mobile phone;
determining whether the interchangeable cover is being put to use for the first time; and
upon determining that the interchangeable cover is being put to use for the first time, transmitting a message to convey the fact that the interchangeable cover is being put to use for the first time.

10. The method of claim 9, wherein the message is transmitted to facilitate compensation for at least a selected one of a contributor of the content, a manufacturer of the wireless mobile phone, and a wireless mobile phone service provider providing wireless mobile phone service to the wireless mobile phone.

11. The method of claim 9, wherein said determining comprises determining whether an indicator within said interchangeable cover denotes the interchangeable cover not having been put to use.

12. The method of claim 11, wherein the method further comprises upon determining that the interchangeable cover is being put to use for the first time, modifying said indicator within said interchangeable cover to denote the interchangeable cover has been put to use.

13. The method of claim 9, wherein said transmitting of a message comprises transmitting a SMS message.

14. A wireless mobile phone comprising:
a detector to detect attachment of an interchangeable cover having content for use to customize the wireless mobile phone;
storage medium having stored therein a plurality of programming instructions designed to
determine whether the interchangeable cover is being put to use for the first time; and
upon determining that the interchangeable cover is being put to use for the first time, transmit a message to convey the fact that the interchangeable cover is being put to use for the first time; and
a processor coupled to the storage medium to execute the programming instructions.

15. The wireless mobile phone of claim 14, wherein the message is transmitted to facilitate compensation for at least a selected one of a contributor of the content, a manufacturer of the wireless mobile phone, and a wireless mobile phone service provider providing wireless mobile phone service to the wireless mobile phone.

16. The wireless mobile phone of claim 14, wherein said programming instructions are designed to perform said determining by determining whether an indicator within said interchangeable cover denotes the interchangeable cover not having been put to use.

17. The wireless mobile phone of claim 16, wherein the programming instructions are further designed to modify said indicator within said interchangeable cover to denote the interchangeable cover has been put to use, upon determining that the interchangeable cover is being put to use for the first time.

18. The wireless mobile phone of claim 14, wherein the programming instructions are further designed to transmit said message as a SMS message.

19. A wireless mobile phone interchangeable cover comprising:
a cover body;
a storage medium disposed on a surface of the cover body;
content for use to customize a wireless mobile phone to which the interchangeable cover is attached; and
an indicator to denote whether the interchangeable cover has been put to use.

20. The interchangeable cover of claim 19, wherein the indicator facilitates compensation for at least a selected one of a contributor of the content, a manufacturer of the wireless mobile phone, and a wireless mobile phone service provider providing wireless mobile phone service to the wireless mobile phone.

21. In an apparatus, a method of operation comprising:
receiving a message denoting an interchangeable cover having content designed to customize a wireless mobile phone is being put to use for the first time; and
in response, storing the reported first put to use in detail or in aggregate.

22. The method of claim 21, wherein the method further comprises accruing compensation for at least a selected one of a contributor of the content, a manufacturer of the wireless mobile phone, and a wireless mobile phone service provider providing wireless mobile phone service to the wireless mobile phone.

23. The method of claim 22, wherein said accruing comprises accruing compensation for at least two of said contributor of the content, said manufacturer of the wireless mobile phone, and said wireless mobile phone service provider.

24. The method of claim 22, wherein said accruing comprises accruing compensation for each of said contributor of the content, said manufacturer of the wireless mobile phone, and said wireless mobile phone service provider.

25. In an apparatus, a method of operation comprising:
receiving a message denoting an interchangeable cover having content designed to customize a wireless mobile phone is being put to use for the first time; and
in response, accruing compensation for at least a selected one of a contributor of the content, a manufacturer of the wireless mobile phone, and a wireless mobile phone service provider providing wireless mobile phone service to the wireless mobile phone.

26. An apparatus comprising:
a communication interface to facilitate receipt of a message denoting an interchangeable cover having content designed to customize a wireless mobile phone is being put to use for the first time;
storage medium having stored therein a plurality of programming instructions designed to
process the received message, and
in response, store the reported first put to use in detail or in aggregate; and
a processor coupled to the communication interface and the storage medium to execute the programming instructions.

27. The apparatus of claim 26, wherein said programming instructions are further designed to accrue compensation for at least a selected one of a contributor of the content, a manufacturer of the wireless mobile phone, and a wireless mobile phone service provider providing wireless mobile phone service to the wireless mobile phone.

28. The apparatus of claim 27, wherein said programming instructions are designed to accrue compensation for at least two of said contributor of the content, said manufacturer of the wireless mobile phone, and said wireless mobile phone service provider.

29. The apparatus of claim 27, wherein said programming instructions are designed to accrue compensation for each of said contributor of the content, said manufacturer of the wireless mobile phone, and said wireless mobile phone service provider.

30. An apparatus comprising:
a communication interface to facilitate receipt of a message denoting an interchangeable cover having content designed to customize a wireless mobile phone is being put to use for the first time;
storage medium having stored therein a plurality of programming instructions designed to
process the received message, and
in response, to accrue compensation for at least a selected one of a contributor of the content, a manufacturer of the wireless mobile phone, and a wireless mobile phone service provider providing wireless mobile phone service to the wireless mobile phone; and
a processor coupled to the communication interface and the storage medium to execute the programming instructions.
